(19) United States
(12) Patent Application Publication
(10) Pub. No.: US 2010/0132318 A1
(43) Pub. Date: Jun. 3, 2010

(54) RETAINER CONE AND BAG FILTER RETAINER PROVIDED WITH THE SAME

(75) Inventor: Eiji Igawa, Fukuoka (JP)

Correspondence Address: SUGHRUE MION, PLLC, 2100 PENNSYLVANIA AVENUE, N.W., SUITE 800, WASHINGTON, DC, 20037, US

(73) Assignee: SHINKO INDUSTRY CO., LTD., Kitakyushu-shi, Fukuoka (JP)

(21) Appl. No.: 11/815,989

(22) PCT Filed: Sep. 13, 2006
(86) PCT No.: PCT/JP2006/318185

§ 371 Date: Aug. 10, 2007

(30) Foreign Application Priority Data
Jul. 5, 2006 (JP) 2006-186046

(51) Int. Cl. B01D 46/02

(52) U.S. Cl. 55/379

(57) ABSTRACT

It is an object of the present invention to provide a retainer cone that, by internally inserting the retainer cone into the central portion at the upper end portion of the retainer main body, which is an area, where negative pressure is generated, in the vicinity of the attaching portion of a prior art venturi tube, is capable of dispersing a part of the compressed air jetted from a nozzle at the upper part of the retainer main body, when carrying out reverse air filtration of a filtration fabric, in the radius direction of the retainer main body, preventing negative pressure from being generated at the upper end side of the retainer main body, outwardly inflating the entire filtration fabric including the upper end side of the retainer main body, securely shaking off powder dust adhered to the filtration fabric, and simultaneously enlarging the sectional area of a flow path at the upper end portion of the retainer main body in comparison with a prior art venturi type, and significantly reducing the load of a blower used for suction when collecting dust, wherein the retainer cone internally inserted into the central portion at the upper end side of the retainer main body of the bag filter retainer, which includes an upper end shrinkage portion disposed at the upper end portion in the lengthwise direction thereof so that the diameter is caused to shrink toward the upper end, and a lower end shrinkage portion formed at the lower end portion in the lengthwise direction thereof so that the diameter thereof is caused to shrink toward the lower end.

### TECHNICAL FIELD

The present invention relates to a retainer cone disposed in a bag filter retainer which supports a filtration fabric of a dust collector from the inside, and a bag filter retainer provided with the same.

### BACKGROUND ART

Conventionally, such a type of dust collector has been used as a dust collector, which includes a filtration fabric (filter bag) for separating, catching, and collecting powder dust by causing dust-contained airflows to pass therethrough and a supporting frame (a so-called retainer main body) for supporting the filtration fabric from its inside to keep the shape of the filtration fabric. As the dust collector is run, the filtration fabric catches and collects powder dust, wherein the loss of its suction force is increased in line with elapse of the running time. Therefore, it is necessary to intermittently or continuously shake off caught and collected powder dust. As such a mechanism to shake off powder dust, a pulse jet type dust collector is disclosed in, for example, (Patent Document 1) and (Patent Document 2).

FIG. 7A is a schematic sectional view of the major parts of a dust collector equipped with a pulse jet type shake-off mechanism, which shows a state of a filtration fabric of a prior art bag filter retainer when collecting dust, FIG. 7B is a schematic sectional view of the major parts showing a state of the filtration fabric when shaking off (that is, carrying out reverse air filtration of) powder dust in regard to a prior art bag filter retainer in a dust collector equipped with a pulse jet type shake-off mechanism.

In FIG. 7, reference numeral 50 denotes a prior art bag filter retainer disposed on the top of a dust collector equipped with a pulse jet type shake-off mechanism 70. Reference numeral 51 denotes the main body of the bag filter retainer 50. Reference numeral 52 denotes a venturi tube disposed and fixed at the upper end portion of the retainer main body 51. Reference numeral 52a denotes a flange portion at the upper end of the venturi tube 52. Reference numeral 55 denotes a cylindrical filtration fabric disposed at the outer circumference of the retainer main body 51. Reference numeral 60 denotes a partitioning plate (cell plate) of the dust collector, which retains the bag filter retainer 50, and reference numeral 70a denotes a nozzle of a pulse jet type shake-off mechanism which is disposed upwards of the venturi tube 52 and jets compressed air into the venturi tube 52.

Since the dust-contained airflows flown into a dust collector chamber through an inlet of the dust-contained airflows of the dust collector is suctioned by a blower (that is, negative pressure: approx. −0.12 kPa through −0.11 kPa), and as shown in FIG. 7A, the dust-contained airflows is dedusted from the outside of the filtration fabric 55 and is flown into the filtration fabric 55, wherein powder dust is caught and collected by the outer circumference of the filtration fabric 55, and clean airflows from which powder dust is separated, caught, and collected is discharged through the venturi tube 52. The nozzle 70a of the shake-off mechanism 70 is disposed upwards of the venturi tube 52, and as shown in FIG. 7B, compressed air from the nozzle 70a is jetted from the venturi tube 52 to the interior of the filtration fabric 55 once every fixed duration of time, and powder dust adhered to the filtration fabric 55 is instantaneously shaken off outwardly of the filtration fabric 55.

[Patent Document 1] Japanese Published Unexamined Patent Application No. H10-211410

[Patent Document 2] Japanese Published Unexamined Patent Application No. H8-299732

### DISCLOSURE OF THE INVENTION

### Objects to be Solved by the Invention

However, when having observed movements of the filtration fabric 55 when shaking off powder dust with respect to the pulse jet type dust collector, it was found that, since the jet speed is fast and the blow volume is great when jetting a pulse jet (compressed air) from the nozzle 70a, negative pressure may be generated due to the venturi effect in the vicinity of the outer circumference of the venturi tube 52 at the upper end side of the retainer main body 51, and as shown in FIG. 7B, the filtration fabric 55 is made into a suction state while being pulled and attached to the retainer main body 51, wherein it was impossible to shake off powder dust at the upper end portion of the filtration fabric 55. Therefore, the pressure was measured with a sensor (digital fine pressure difference meter) attached in the lengthwise direction of the retainer main body 51. It was also found that negative pressure is generated in the vicinity of the outer circumference of the venturi tube 52 in an almost fixed range of 500 mm through 600 mm from the upper end of the filtration fabric 55 regardless of the entire length (3 m through 9 m) of the retainer main body 51. FIG. 8(a) through FIG. 8(c) are views showing the results of measurement of pressure at respective positions at 200 mm, 350 mm and 3000 mm from the upper end when a pulse jet (compressed air) whose pressure is 294 kPa is jetted for 0.2 seconds. Further, the phenomenon was also confirmed in a case where no venturi tube 52 is provided.

Based on the above description, the following problematic points were made clear in the prior arts.

(1) Since the jet speed is fast (approx. 90 meters per second) even if a pulse jet (compressed air) of positive pressure is jetted, the duration of time during which positive pressure is generated is only an instant (approx. 0.02 seconds) (Refer to FIGS. 8(a) and (b)), the filtration fabric 55 cannot react, and at the upper end of the filtration fabric 55, the positive pressure in the filtration fabric 55 by the pulse jet and the negative pressure for suction of a blower at the upper part of the partitioning plate (cell plate) 60 are pulled against each other, wherein the interior of the filtration fabric 55 becomes a vacuum state, and the filtration fabric 55 remains adhered to the retainer main body 51 side while being intensively pulled to the retainer main body 51 side. Therefore, powder dust at the upper end portion of the filtration fabric 55 cannot be shaken off, wherein the dust collection efficiency is decreased.
(2) The pressure of the interior of the retainer main body 51 is decreased by passage of a high-speed pulse jet (compressed air) through the venturi tube 52, and dust-contained airflows existing outside the bag filter retainer 50 pass through the filtration fabric 55 and are suctioned to the interior of the retainer main body 51. However, the dust-contained airflows cannot be passed through the filtration fabric 55 due to resistance of the filtration fabric 55 in a short time, wherein, since clean airflows cannot be supplied into the interior of the retainer main body 51 in time, negative pressure is generated. Such a suctioning state is generated with the filtration fabric 55 intensively pulled to the outer circumference of the retainer main body 51 by both the above negative pressure and the negative pressure based on suction of the blower, wherein the filtration fabric 55 is rubbed against the retainer main body 51 and is likely to be damaged, wherein the service life of the filtration fabric 55 is not made sufficient.
(3) In particular, at the position of the boundary, where negative pressure is changed to positive pressure, apart by 500 mm through 600 mm from the upper end of the filtration fabric 55, the filtration fabric 55 is excessively pulled inward and outward, wherein damage due to bending becomes remarkable.
(4) Where the pulse jet pressure is increased or the venturi tube 52 is removed, or where the venturi tube 52 is attached while being projected outward of the retainer main body 51, the negative pressure of the upper end portion of the filtration fabric 55 is further increased, and the filtration fabric 55 is likely to be damaged. For this reason, the pressure of the pulse jet is usually in a range of approx. 196 kPa through 686 kPa. However, there are cases where the pulse jet pressure restricted to 392 kPa or less in order to prevent breakage of the filtration fabric 55. As a result, in the case of a long retainer, the pulse jet does not reach the lower end of the retainer main body 51, wherein there are cases where powder dust cannot be shaken off both the upper and the lower ends.
(5) Since the venturi tube 52 is disposed in the interior of the retainer main body 51, the sectional area of a flow path at the upper end portion of the retainer main body 51 is decreased, and the velocity of clean airflows becomes fast when suctioning by the blower, wherein the pressure loss is increased. Also, no bypass of clean airflows is provided in the outer circumference of the venturi tube 52 for the flange portion 52a at the upper end of the venturi tube 52, wherein a clean airflows is accumulated to cause the suction efficiency to be decreased.
(6) Where the opening area is increased by providing a plurality of openings (pores exclusively used for blower suction) on the circumference of the flange portion 52a at the upper part of the venturi tube 52, it is possible to reduce the load of the blower when collecting dust and to increase the suction force. However, when jetting a pulse jet when shaking off powder dust, pulling based on pressure is made intensive, which is brought about between the positive pressure in the filtration fabric 55 due to the pulse jet and the negative pressure for suction of the blower at the upper part of the partitioning plate (cell plate) 60, wherein the negative pressure of the upper end portion of the filtration fabric 55 is increased, and at the same time, the positive pressure of the pulse jet does not reach the lower end of the retainer main body 51, wherein the effect of shaking off powder dust becomes insufficient.

The present invention solves the above-described problems of the prior arts. It is therefore an object of the present invention to provide a retainer cone that, by being internally inserted into the center of the upper end portion of the retainer main body, which is a negative pressure generation area in the vicinity of the attaching position of a prior art venturi tube, is capable of preventing negative pressure from being generated at the upper end side of the retainer main body by dispersing a part of the compressed air jetted from the nozzle at the upper part of the retainer main body in the radius direction of the retainer main body when carrying out reverse air filtration of a filtration fabric, inflating the entire filtration fabric including the upper end side of the retainer main body outward, securely shaking off powder dust adhered to the filtration fabric, simultaneously enlarging the sectional area of a flow path at the upper end portion of the retainer main body in comparison with a prior art venturi type, and significantly reducing the load of a blower used for suction when collecting dust, and to provide a bag filter retainer that, by providing the above-described retainer cone, is capable of preventing the filtration fabric from being damaged by alleviating sticking of the filtration fabric at the upper end side of the retainer main body when carrying out reverse air filtration, has an excellent service life in regard to the filtration fabric, is capable of widening an effective filtration area when collecting dust and improving the dust collection efficiency, and brings about an excellent energy-saving effect.

### Means for Solving the Objects

In order to solve the above-described objects, a retainer cone according to the present invention and a bag filter retainer equipped with the same has the following configuration.

A retainer cone according to a first aspect of the present invention is a retainer cone that is internally inserted into and is disposed in the center portion at the upper end side of the retainer main body of a bag filter retainer, and includes an upper end shrinkage portion shrunk toward the upper end and formed at the upper end portion in the lengthwise direction and a lower end shrinkage portion shrunk toward the lower end and formed at the lower end portion in the lengthwise direction.

With the configuration, the following actions may be brought about.

(1) Since the retainer cone is provided with an upper end shrinkage portion shrunk toward the upper end and formed at the upper end portion in the lengthwise direction of the retainer cone, it is possible to disperse a part of the compressed air in the radius direction (the outer-circumferential direction) of the retainer main body by reflecting a part of the compressed air by the inclined surface of the upper end shrinkage portion when compressed air is jetted from the nozzle disposed at the upper part of the bag filter retainer when carrying out reverse air filtration of the filtration fabric, wherein it is possible to prevent negative pressure from being generated at the upper end side of the retainer main body, and to uniformly inflate the entire filtration fabric including the upper end side of the retainer main body outward of the retainer main body, and it is possible to securely shake off powder dust adhered to the filtration fabric. Therefore, maintenance reliability is excellent, dust collection efficiency may be improved by widening the effective filtration area when collecting dust, and the excellent energy-saving effect may be brought about.
(2) Since, when carrying out reverse air filtration of the filtration fabric, a part of the compressed air jetted from the nozzle disposed at the upper part of the bag filter retainer is dispersed from the upper end shrinkage portion in the radius direction (the outer-circumferential direction) of the retainer main body, it is possible to prevent negative pressure from being generated at the upper end side of the retainer main body and to prevent the filtration fabric from being damaged by alleviating sticking of the filtration fabric due to intensive pulling against the retainer main body at the upper end side of the retainer main body, wherein the service life of the filtration fabric may be improved.
(3) Since the retainer cone is internally inserted into the center portion at the upper end side of the retainer main body of the bag filter retainer, it is possible to further enlarge the sectional area of a flow path at the upper end portion of the retainer main body in comparison with a prior art venturi tube, using the outer circumference of the retainer cone as a flow path, and it is possible to significantly reduce the load of a blower used for suction when collecting dust, wherein an excellent energy-saving effect may be brought about.
(4) Since a lower end shrinkage portion is provided which is shrunk toward the lower end and formed at the lower end portion in the lengthwise direction of the retainer cone, it is possible to smoothly move filtrated clean airflows to the upper stream side along the inclined surface of the lower end shrinkage portion when suctioning by means of a blower when collecting dust, wherein the pressure loss is only slight, and suction efficiency is excellent.

Herein, such a shape as having an upper end shrinkage portion and a lower end shrinkage portion at the upper end and the lower end, respectively, may be sufficient as the shape of the retainer cone. In particular, where the retainer cone is formed of an axis-symmetrical rotating body, streams of compressed air when carrying out reverse air filtration and clean airflows when collecting dust may be made uniform on the entire circumference, it is preferable that efficient filtration may be evenly carried out on the entire surface of the filtration fabric.

The shape of the upper end shrinkage portion and the lower end shrinkage portion of the retainer cone may be preferably a conical shape, a semi-spherical shape, an elliptic semi-spherical shape, a cannonball-shape, or polygonal cone, etc.

The entire shape of the retainer cone may be preferably a bicone type (abacus ball type) having a conical upper end shrinkage portion and a conical lower end shrinkage portion vertically symmetrically disposed, and a spindle type in which a lower end shrinkage portion being a conical shape, a semi-spherical shape, an elliptic semi-spherical shape, or a cannonball-shape, etc. is combined with the conical upper end shrinkage portion. In this case, an excellent rectification effect may be brought about, thereby smoothening the streams of airflows, wherein it is possible to reduce the pressure loss.

Also, the upper end shrinkage portion and the lower end shrinkage portion may be continuously formed, or a columnar barrel portion or a square pillar-shaped barrel portion may be formed between the upper end shrinkage portion and the lower end shrinkage portion. By providing the columnar barrel portion or a square pillar-shaped barrel portion, it is possible to adjust the entire length of the retainer cone or to utilize the barrel portion to attach the retainer cone to a bag filter retainer.

When attaching the retainer cone to the bag filter retainer, the retainer cone may be fixed so as to be suspended from the upper end side of the retainer main body, or may be supported from the outer-circumferential side of the retainer main body.

It is favorable that the attaching height of the retainer cone is set so that the entire length of the retainer cone is accommodated in a range of a negative pressure generation area in the vicinity of the attaching position of a prior art venturi tube.

The maximum sectional area (horizontal projection area) of the retainer cone may change in accordance with the lengths and shapes of the upper end shrinkage portion and the lower end shrinkage portion. However, it is preferable that the maximum sectional area thereof is formed to be 0.2 times through 0.4 times the sectional area (horizontal projection area) of the retainer main body. As the maximum sectional area (horizontal projection area) of the retainer cone becomes smaller than 0.2 times the sectional area (horizontal projection area) of the retainer main body, it becomes difficult to disperse compressed air, which is jetted in reverse air filtration, to the outer circumference of the retainer cone, and a negative pressure reducing effect is decreased, wherein there is a tendency by which shaking-off of powder dust is likely to insufficient at the upper end portion of the retainer main body. As the maximum sectional area thereof exceeds 0.4 times, the sectional area of a flow path at the upper end portion of the retainer main body becomes insufficient, and the amount of compressed air that may reach the lower end side of the retainer main body becomes insufficient in reverse air filtration, wherein there is a tendency by which shaking-off of powder dust becomes insufficient at the lower end side, simultaneously the load of the blower is increased when collecting dust, and the drive efficiency has a tendency to be decreased, none of which is favorable.

A second aspect of the present invention is a retainer cone according to the first aspect, wherein the upper end shrinkage portion and the lower end shrinkage portion are formed of any one of the shapes which are a conical shape, a semi-spherical shape, an elliptic semi-spherical shape, a cannonball-shape, or a polygonal cone.

With such a configuration, the following actions are brought about in addition to the actions obtained by the first aspect.

(1) Since the upper end shrinkage portion of the retainer cone is formed of any one of the shapes which are a conical shape, a semi-spherical shape, an elliptic semi-spherical shape, a cannonball-shape, or a polygonal cone-shape, it is possible to radially disperse compressed air jetted when carrying out reverse air filtration from the center (the axial center) of the retainer main body toward the outer circumferential side, and possible to securely inflate the filtration fabric at the upper end side of the retainer main body outward over the entire circumference, wherein powder dust may be efficiently shaken off.
(2) Since the lower end shrinkage portion of the retainer cone is formed of any one of the shapes which are a conical shape, a semi-spherical shape, an elliptic semi-spherical shape, a cannonball-shape, or a polygonal cone-shape, it is possible to move clean airflows, which are suctioned when collecting dust, to the upstream side along the entire circumference of the lower end shrinkage portion, wherein the load of the blower may be reduced and the energy-saving effect thereof is excellent.

Herein, it is favorable that the angle of the top part of the upper end shrinkage portion of the retainer cone is formed to be 50 through 90 degrees, preferably 65 through 75 degrees while it changes according to the length of the upper end shrinkage portion.

As the angle of the top part of the upper end shrinkage portion of the retainer cone becomes smaller than 65 degrees, it becomes difficult to disperse compressed air jetted when carrying out reverse air filtration to the outer circumferential side of the retainer cone, wherein the negative pressure reducing effect is likely to be decreased, and there is a tendency that shaking-off of powder dust at the upper end portion of the retainer main body becomes insufficient. Contrarily, as the angle exceeds 75 degrees, the amount of compressed air that may reach the lower end side of the retainer main body in reverse air filtration is decreased, wherein there is a tendency that shaking-off of powder dust at the lower end side of the retainer main body becomes insufficient. In particular, if the angle of the top part of the upper end shrinkage portion of the retainer cone becomes smaller than 50 degrees, it becomes difficult to disperse compressed air jetted when carrying out reverse air filtration to the outer circumferential side of the retainer cone to remarkably decrease the negative pressure reducing effect, wherein it becomes difficult to shake off powder dust at the upper end portion of the retainer main body. If the angle exceeds 90 degrees, the sectional area of a flow path at the upper end portion of the retainer main body becomes insufficient, and the amount of compressed air, which reaches the lower end side of the retainer main body in reverse air filtration, is remarkably decreased, wherein it becomes difficult to shake off powder dust at the lower end side of the retainer main body, and at the same time, the load of the blower when collecting dust is increased to cause the energy saving effect to be worsened, none of which is favorable.

It is favorable that the angle of the top part of the lower end shrinkage portion of the retainer cone is formed to be 40 through 90 degrees, preferably 65 through 75 degrees while changing according to the length of the lower end shrinkage portion and the suction force of a blower. As the angle of the top part of the lower end shrinkage portion of the retainer cone becomes smaller than 65 degrees, there is a tendency that the lower end shrinkage portion is lengthened, and it becomes difficult to work and handle the lower end shrinkage portion. As the angle becomes larger than 75 degrees, there is a tendency that it becomes difficult for clean airflows suctioned when collecting dust to smoothly move along the lower end shrinkage portion. In particular, if the angle of the top part of the lower end shrinkage portion of the retainer cone becomes smaller than 40 degrees, productivity thereof is remarkably decreased to cause its handling to become difficult, wherein fixing and stabilization are made insufficient. If the angle becomes larger than 90 degrees, clean airflows suctioned when collecting dust is brought into collision with the lower end shrinkage portion and is dispersed in the outer circumferential direction of the retainer main body, wherein the suction efficiency is decreased to cause the filtration performance to become insufficient, none of which is favorable.

A bag filter retainer according to a third aspect of the present invention includes: a retainer main body consisting of a plurality of fixing rings which are formed of metallic wires and disposed with predetermined spacing, and a plurality of longitudinal line members jointed to the exterior of the fixing ring; a retainer cone according to any one of the first through third aspects, which is internally inserted into and disposed in the center portion at the upper end side of the retainer main body; and a fixing member for fixing the retainer cone on the retainer main body.

With such a configuration, the following actions may be brought about.

(1) Since the retainer cone is internally inserted into and disposed in the center portion at the upper end side of the retainer main body, a part of the compressed air jetted from the nozzle at the upper part of the retainer is dispersed in the radius direction of the retainer main body when carrying out reverse air filtration of the filtration fabric, it is possible to prevent negative pressure from being generated at the upper end side of the retainer main body, the entire filtration fabric including the upper end side of the retainer main body may be outwardly inflated, and it is possible to securely shake off powder dust adhered to the filtration fabric, wherein an effective filtration area may be widened when collecting dust to improve the dust collection efficiency, and at the same time, it is possible to alleviate intensive pulling of the filtration fabric toward the retainer main body at the upper end side of the retainer main body, thereby preventing the filtration fabric from being damaged, an excellent longer service life of the filtration fabric may be achieved.
(2) Since the retainer cone is internally inserted into and disposed in the center portion at the upper end side of the retainer main body, it is possible to expand the sectional area of a flow path at the upper end portion of the retainer main body in comparison with a prior art venturi type, and possible to significantly reduce the load of the blower used for suction when collecting dust, wherein an excellent energy-saving effect may be brought about.
(3) Since the retainer is provided with a fixing member for fixing the retainer cone on the retainer main body, the retainer cone is simply attached to the existing retainer main body, and the existing retainer main body may be effectively utilized, wherein the filtration performance and service life of the filtration fabric may be improved to a large extent.
(4) Since the negative pressure for suction by a blower when collecting dust is increased at the upper end portion of the retainer main body near the blower, the adhering amount of powder dust at the upper end portion of the filtration fabric is increased. However, since negative pressure due to a pulse jet (compressed air) is prevented, by attaching the retainer cone, from occurring when carrying out reverse air filtration, it is possible to obtain high positive pressure at the upper end side of the retainer main body, wherein an effect of shaking off powder dust at the upper end portion of the filtration fabric may be improved, and an excellent energy-saving effect may be brought about.
(5) Since positive pressure is generated in the interior of the retainer main body by a negative pressure-reducing effect when carrying out reverse air filtration of the retainer cone, in proportion to the pressure of a pulse jet (compressed air) when carrying out reverse air filtration, and the filtration fabric may be deformed, it is possible to select the pressure of a pulse jet (compressed air) in a wide range from lower pressure (for example, approximately 196 kPa) to high pressure (for example, approximately 686 kPa), wherein it is easy to control the pressure of the pulse jet (compressed air), and excellent handling performance and versatility may be brought about.

Herein, any member that is able to fix the retainer cone on the retainer main body is available as the fixing member. However, it is favorable that the fixing member is structured and arranged so that it does not hinder streams of airflows between the retainer main body and the retainer cone, which becomes a flow path. In detail, such a type may be preferably used, in which rod-shaped members such as metallic wires are disposed on the outer circumference of the retainer cone parallel to the lengthwise direction of the retainer main body, and the distal ends thereof are bent to the outer circumferential side of the retainer main body and are fixed by welding, etc. on the fixing ring or longitudinal line member of the retainer main body, or on an annular-shaped flange portion disposed at the upper end portion of the retainer main body, and such a type may be preferably used, in which rod-shaped members such as metallic wires are radially disposed in the radius direction of the retainer main body on the outer circumference of the retainer cone, and the distal ends thereof are fixed by welding, etc. on, the fixing ring or longitudinal line member of the retainer main body.

A bag filter retainer according to a fourth aspect of the present invention is a bag filter retainer according to the third aspect thereof, wherein the fixing member includes a suspension member disposed parallel to the lengthwise direction of the retainer main body on the outer circumference of the retainer cone; and an extension portion which extends from the suspension portion, is fixed on the annular-shaped flange portion disposed on the upper end portion of the retainer main body.

With such a configuration, the following actions may be brought about in addition to the actions obtained by the third aspect.

(1) Since the suspension portion of the fixing member is disposed parallel to the lengthwise direction of the retainer main body on the outer circumference of the retainer cone, the extension portion may be easily fixed so that the extension portion extending on the suspension portion is locked on the annular-shaped flange portion disposed at the upper end portion of the retainer main body without hindering streams of clean airflows when collecting dust and compressed air when carrying out reverse air filtration, wherein its attaching work efficiency is excellent.

Herein, such a type may be preferably used as the fixing member, in which rod-shaped members such as metallic wires are formed to be roughly L-shaped. If the fixing member is fixed, by welding, etc. on the outer circumference of the retainer cone in advance, it is possible to fix the retainer cone so that it is internally inserted into the retainer main body and is suspended therefrom. The retainer cone may be fixed by its self-weight only by locking the extension portion at the annular-shaped flange portion. However, if a fitting recess or a holding portion is provided at the annular-shaped flange portion, the extension portion may be securely held, wherein it is possible to effectively prevent the retainer cone from positional slip, turning, and play. Also, where a flat annular-shaped member is disposed at the distal end of the extension portion and is screwed into the annular-shaped flange portion, or the extension portion and the annular-shaped flange portion are directly welded to each other, the retainer main body and the retainer cone may be securely and firmly fixed, wherein the fixing may be further stabilized.

It is preferable that the quantity of the fixing members is 2 through 6. If the fixing member is a single member, the retainer cone is supported only at one end, wherein the fixing reliability is lost. On the other hand, if the quantity thereof exceeds 6, the resistance of the flow path is increased, wherein the stream of airflows is likely to be hindered, and there is a tendency that the suction efficiency of the blower is decreased, none of these is favorable. In addition, it is preferable that the fixing members are disposed so as to be spaced from each other at equal angles in the circumferential direction of the retainer cone, wherein the stream of airflows is made even over the entire circumference, it is possible to uniformly shake off powder dust, and the filtration performance is well stabilized.

A bag filter retainer according to a fifth aspect of the present invention is a bag filter retainer according to the third aspect thereof, wherein the fixing members are radially disposed in the radius direction of the retainer main body on the outer circumference of the retainer cone and are fixed to at least any one of the longitudinal line members of the retainer main body and the fixing ring thereof.

With such a configuration, the following actions may be brought about in addition to those obtained in the third aspect.

(1) Since the fixing members are radially disposed in the radius direction of the retainer main body on the outer circumference of the retainer cone, and are fixed to at least any one of the longitudinal line members of the retainer main body and the fixing rings thereof, it is possible to securely support the outer circumference of the retainer cone without hindering the stream of clean airflows when collecting dust and of compressed air when carrying out reverse air filtration, wherein the fixing is well stabilized.

Herein, a rod-shaped member such as a metallic wire may be preferably used as the fixing member. If one end of the fixing member is fixed at the outer circumference of the retainer cone in advance by welding or screwing, etc. it is possible to securely and firmly fix the retainer main body and the retainer cone by internally inserting the retainer cone into the retainer main body and welding the other end of the fixing member to at least any one of the longitudinal line members of the retainer main body and the fixing ring thereof.

Also, the quantity and arrangement of the fixing members are the same as in the fourth aspect of the present invention. Therefore, the description thereof is omitted.

### EFFECTS OF THE INVENTION

As described above, with the retainer cone according to the present invention and the bag filter retainer equipped with the same, the following advantageous effects may be brought about.

According to the first aspect of the present invention,

(1) A part of a pulse jet (compressed air) jetted when carrying out reverse air filtration of the filtration fabric is dispersed in the radius direction (the outer-circumferential direction) of the retainer main body, and the entire filtration fabric including the upper end side of the retainer main body is roughly uniformly outwardly inflated, whereby it is possible to provide a retainer cone that may widen an effective filtration area by securely shaking off powder dust adhered to the filtration fabric, improve maintenance efficiency and dust collection efficiency of a bag filter retainer, and improve the energy-saving performance.
(2) A part of a pulse jet (compressed air) jetted when carrying out reverse air filtration of the filtration fabric is dispersed in the radius direction (the outer-circumferential direction) of the retainer main body, and negative pressure is prevented from being generated at the upper end side of the retainer main body, whereby it is possible to provide a retainer cone that alleviates intensive pulling of the filtration fabric to the retainer main body at the upper end side of the retainer main body, prevents the filtration fabric from being damaged, and is able to improve the service life of the filtration fabric.
(3) The retainer cone is internally inserted into the center portion at the upper end side of the retainer main body, whereby it is possible to provide a retainer cone that may enlarge the sectional area of a flow path at the upper end portion of the retainer main body in comparison with a prior art venturi tube and may improve the energy-saving performance by significantly reducing the load of a blower used for suction when collecting dust.
(4) It is possible to provide a retainer cone that may smoothly move filtrated clean airflows suctioned by the blower when collecting dust to the upstream side of the retainer main body by guiding the clean airflows and improve the suction efficiency by reducing the pressure loss of the bag filter retainer.

According to the second aspect of the present invention, the following effects may be brought about in addition to those obtained by the first aspect thereof.

(1) It is possible to provide a retainer cone that is able to roughly uniformly disperse compressed air jetted when carrying out reverse air filtration from the center (the axial center) of the retainer main body toward the outer circumferential side at the upper end shrinkage portion without any unevenness, to securely outwardly inflate the filtration fabric at the upper end side of the retainer main body over the entire circumference thereof, and to improve the shaking-off efficiency of powder dust of the bag filter retainer.
(2) It is possible to provide a retainer cone that is able to roughly uniformly move clean airflows suctioned when collecting dust, to the upstream side along the entire circumference of the lower end shrinkage portion without any unevenness, and to improve the energy-saving performance by reducing the load of the blower.

According to the third aspect of the present invention,

(1) It is possible to provide a bag filter retainer that is able to prevent negative pressure from being generated at the upper end side of the retainer main body by dispersing a part of the compressed air jetted when carrying out reverse air filtration of the filtration fabric in the radius direction of the retainer main body, to securely shake off powder dust adhered to the filtration fabric by outwardly inflating the entire filtration fabric including the upper end side of the retainer main body, is excellent in maintenance performance, is able to improve the dust collection efficiency by widening an effective filtration area when collecting dust, simultaneously to provide a bag filter retainer that alleviates intensive pulling of the filtration fabric toward the retainer main body at the upper end side of the retainer main body, prevents the filtration fabric from being damaged, and is excellent in service life of the filtration fabric.
(2) It is possible to provide a bag filter retainer having excellent energy-saving performance, which is able to enlarge the sectional area of a flow path of the upper end portion of the retainer main body in comparison with a venturi tube type and to significantly reduce the load of the blower used for suction when collecting dust.
(3) It is possible to provide a bag filter retainer being excellent in maintenance performance and energy-saving performance, which is able to obtain high positive pressure at the upper end side of the retainer main body by preventing negative pressure from being generated due to a pulse jet (compressed air) in reverse air filtration with a retainer cone attached, to securely outwardly inflate the entire filtration fabric including the upper end side of the retainer main body, and to improve an effect of shaking off powder dust adhered to the filtration fabric.
(4) It is possible to provide a bag filter retainer being excellent in versatility and maintenance reliability and easy in handling, in which the range of selection for pressure of a pulse jet (compressed air) is wide since it is possible to deform the filtration fabric in proportion to pressure of the pulse jet (compressed air) when carrying out reverse air filtration.

According to the fourth aspect of the present invention, in addition to the effects of the third aspect,

(1) It is possible to provide a bag filter retainer the attaching work efficiency of which is excellent because a retainer cone may be easily attached so as to be suspended from the upper end portion of the retainer main body, and the reliability of which is excellent because the retainer does not hinder streams of clean airflows when collecting dust and compressed air when carrying out reverse air filtration.

According to the fifth aspect of the present invention, in addition to the effects of the third aspect,

(1) It is possible to provide a bag filer retainer, the fixing stability of which is excellent because the retainer cone may be securely supported from the outer circumference without hindering streams of clean airflows when collecting dust and compressed air when carrying out reverse air filtration.

### BRIEF DESCRIPTION OF THE DRAWINGS

FIG. 1 is a front elevational view of a retainer cone according to Embodiment 1 of the present invention;

FIG. 2 is a front elevational view showing the section of the major parts of a bag filter retainer equipped with the retainer cone according to Embodiment 1 of the present invention;

FIG. 3 is a plan view showing a bag filter retainer equipped with a retainer cone according to Embodiment 1 of the present invention;

FIG. 4A is a schematic sectional view of the major parts, which shows a state of the filtration fabric of the bag filter retainer equipped with the retainer cone according to Embodiment 1 of the present invention when collecting dust; and FIG. 4B is a schematic sectional view of the major parts, which shows a state of the filtration fabric of the bag filter retainer equipped with the retainer cone according to Embodiment 1 of the present invention when carrying out reverse air filtration;

FIG. 5A is a front elevational view showing a first modified version of the retainer cone according to Embodiment 1 of the present invention, FIG. 5B is a front elevational view showing a second modified version of the retainer cone according to Embodiment 1 of the present invention, FIG. 5C is a front elevational view showing a third modified version of the retainer cone according to Embodiment 1 of the present invention, and FIG. 5D is a front elevational view showing a fourth modified version of the retainer cone according to Embodiment 1 of the present invention;

FIG. 6A is a sectional front elevational view of the major parts of the bag filter retainer equipped with the retainer cone according to Embodiment 2 of the present invention; and FIG. 6B is a perspective sectional view taken along the line A-A in FIG. 6A;

FIG. 7A is a schematic sectional view of the major parts, which shows a state of filtration fabric of a prior art bag filter retainer in a dust collector equipped with a pulse jet type shaking-off mechanism when collecting dust, and FIG. 7B is a schematic sectional view of the major parts, which shows a state of filtration fabric of a prior art bag filter retainer in a dust collector equipped with a pulse jet type shaking-off mechanism when shaking off that is carrying out reverse air filtration of powder dust;

FIG. 8 is a view showing the results of measurement of pressure;

FIG. 9 is a view showing the results of measurement of pressure;

FIG. 10 is a view showing the results of measurement of pressure; and

FIG. 11 is a view showing the results of measurement of pressure.

### DESCRIPTION OF REFERENCE NUMERALS

1, 1a, 1b, 1c, 1d Retainer cones
2, 2b Upper end shrinkage portions
2a, 3a, 3a′ Top parts
3, 3b, 3c, 3d Lower end shrinkage portions
4 Columnar barrel portion
4a Square pillar-shaped barrel portion
10,10a, 50 Bag filter retainer
11, 51 Retainer main body
12 Fixing ring
Longitudinal line member
Annular-shaped flange portion
14a Opening
14b Opening edge portion
15,15b Fixing members
16a Suspension portion
16b Extension portion
20,60 Partitioning plates (Cell plates)
25,55 Filtration fabric
30,70 Shaking-off mechanism
30a,70a Nozzles
52 Venturi tube
52a Flange portion

### BEST MODE FOR CARRYING OUT THE INVENTION

Hereinafter, a description is given of a best mode for carrying out the present invention with reference to the drawings.

### Embodiment 1

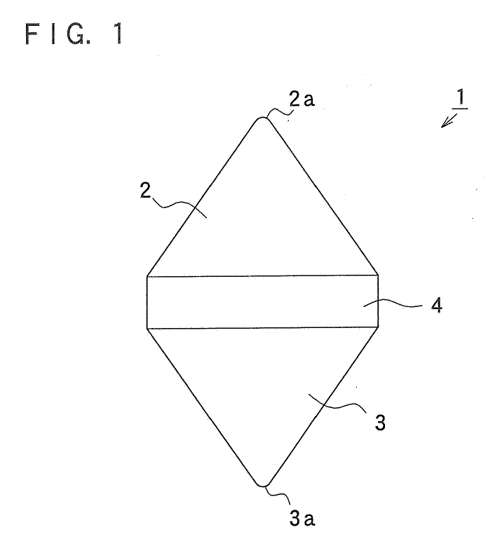

FIG. 1 is a front elevational view showing a retainer cone according to Embodiment 1 of the present invention. In FIG. 1, reference numeral 1 denotes a retainer cone, which is formed to be a bicone type (abacus ball type), according to Embodiment 1 of the present invention. Reference numeral 2 denotes an upper end shrinkage portion of the retainer cone 1, which shrinks toward the upper end and is formed to be conical at the upper end portion in the lengthwise direction thereof. Reference numeral 2a denotes a top part of the upper end shrinkage portion 2. Reference numeral 3 denotes a lower end shrinkage portion of the retainer cone 1, which shrinks toward the lower end and is formed to be conical at the lower end portion in the lengthwise direction thereof, and 3a denotes a top part of the lower end shrinkage portion 3. Reference numeral 4 denotes a columnar barrel portion formed between the upper end shrinkage portion 2 and the lower end shrinkage portion 3.

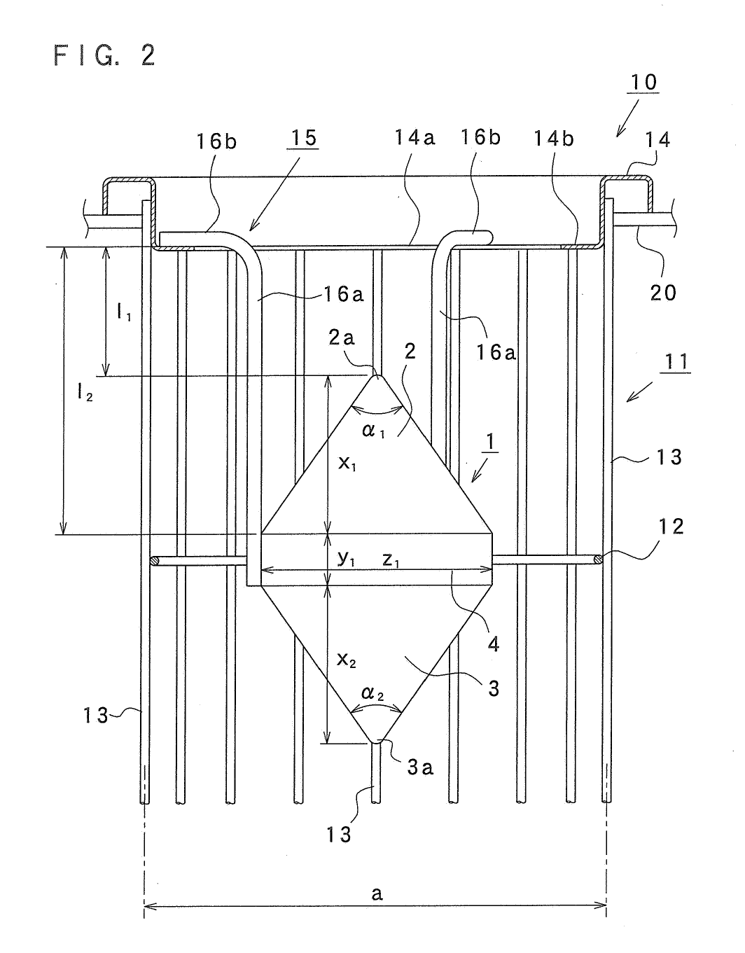

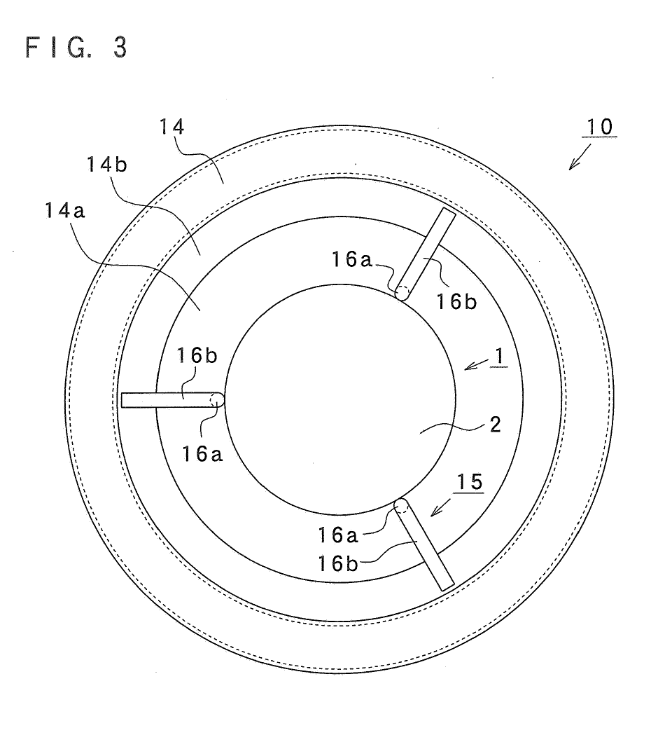

FIG. 2 is a front elevational view showing the section of the major parts of a bag filter retainer equipped with the retainer cone according to Embodiment 1 of the present invention, and FIG. 3 is a plan view showing a bag filter retainer equipped with a retainer cone according to Embodiment 1 of the present invention.

In FIG. 2 and FIG. 3, reference numeral 10 denotes a bag filter retainer having a retainer cone 1 according to Embodiment 1 internally inserted into and disposed in the center portion at the upper end side of the retainer main body 11. Reference numeral 12 denotes a plurality of fixing rings for fixing the retainer main body 11, which are annularly formed of metallic wires such as stainless steel wires, etc. and are disposed with predetermined spacing therebetween. Reference numeral 13 denotes a plurality of longitudinal line members of the retainer main body 11, which are jointed, by spot welding, etc. on the periphery at the outer circumferential side of the fixing ring 12 formed of metallic wires such as stainless steel wires, etc. Reference numeral 14 denotes an annular-shaped flange portion to fix the retainer main body 11 on the partitioning plate (cell plate) 20 disposed at the upper end portion of the retainer main body 11, 14a denotes an opening formed at the middle part of the annular-shaped flange portion 14, and 14b denotes an opening edge portion of the annular-shaped flange portion 14. Reference numeral 15 denotes fixing members which are formed to be roughly L-shaped by metallic wires such as stainless steel wires, etc., are disposed at three parts with an equiangular spacing on the outer circumference of the columnar barrel portion 4 of the retainer cone 1, and fix the retainer cone 1 on the retainer main body 11. Reference numeral 16a denotes a suspension portion of the fixing member 15, which is disposed parallel to the lengthwise direction of the retainer main body 11, and 16b denotes an extension portion of the fixing member 15, which extends from the suspension portion 16a and is locked and fixed at the opening edge portion 14b of the annular-shaped flange portion 14 disposed at the upper end portion of the retainer main body 11. Reference symbol a denotes the diameter of the retainer main body 11, 1₁ denotes the distance from the upper surface of the annular-shaped flange portion 14 to the top part 2a of the upper end shrinkage portion 2 of the retainer cone 1, 1₂ denotes the attaching height from the upper surface of the annular-shaped flange portion 14 to the upper end of the columnar barrel portion 4 of the retainer cone 1, x₁ denotes the length of the upper end shrinkage portion 2, x₂ denotes the length of the lower end shrinkage portion 3, y₁ denotes the length of the columnar barrel portion 4 of the retainer cone 1, z₁ denotes the diameter of the columnar barrel portion 4 of the retainer cone 1, α₁ denotes the angle of the top part 2a of the upper end shrinkage portion 2 of the retainer cone 1, and α₂ denotes the angle of the top part 3a of the lower end shrinkage portion 3 of the retainer cone 1.

Also, although a filtration fabric formed to be cylindrical, etc. is disposed on the outer circumference of the retainer body 11, illustration thereof is omitted for convenience of the description.

Since the retainer cone 1 is formed as an axially symmetrical body of rotation having an upper end shrinkage portion 2 and a lower end shrinkage portion 3 at the upper end and the lower end, respectively, it is possible to make uniform the streams of compressed air when carrying out reverse air filtration and streams of clean airflows when collecting dust, over the entire circumference, wherein efficient filtration may be carried out on the entire surface of the filtration fabric without any unevenness.

In addition, since the columnar barrel portion 4 is formed between the upper end shrinkage portion 2 and the lower end shrinkage portion 3, it is possible to securely and firmly fix the suspension portion 16a of the fixing member 15 and the retainer cone 1 by welding, etc., wherein it is possible to dispose the suspension portion 16a parallel to the lengthwise direction of the retainer cone 1. Therefore, the retainer cone 1 may be aligned with the axial center of the retainer main body 11, and the retainer cone 1 may be fixed parallel to the lengthwise direction of the retainer main body 11.

If the lower end portion of the suspension portion 16a of the fixing member 15 is fixed, by welding, etc. at the outer circumference of the retainer cone 1 in advance, it is possible to easily insert the retainer cone 1 into the retainer main body 11 while gripping the extension portion 16b of the fixing member 15, wherein the extension portion 16b, etc. may be locked at the opening edge portion 14b of the annular-shaped flange portion 14, suspended therefrom and fixed thereat.

As in the present embodiment, the retainer cone 1 may be fixed by its self-weight only by locking the extension portion 16b at the opening edge portion 14b of the annular-shaped flange portion 14. However, where a fitting recess and a holding part are provided at the opening edge portion 14b of the annular-shaped flange portion 14, it is possible to effectively prevent the retainer cone 1 from being subjected to positional slip, turning and play by holding the extension portion 16b. In addition, where a flat annular-shaped member is disposed at the distal end of the extension portion 16b and is screwed to the opening edge portion 14b of the annular-shaped flange portion 14, and the extension portion 16b is directly welded to the opening edge portion 14b of the annular-shaped flange portion 14, it is possible to securely and firmly fix the retainer main body 11 and the retainer cone 1 together, and the fixing thereof is well stabilized.

Although, in the present embodiment, three fixing members 15 are used, it is possible to appropriately select the quantity of the fixing members 15 in the range of two through six members. If the fixing member 15 is a single member, the retainer cone 1 is supported only at one-side end, wherein the fixing reliability is insufficient. As the quantity of the fixing members 15 exceeds six, the streams of airflows are likely to be hindered to cause the resistance of a flow path to be increased, wherein there is a tendency that the suction efficiency of the blower is decreased.

Also, it is favorable that the fixing members 15 are disposed with equiangular spacing in the circumferential direction of the retainer cone 1, wherein the streams of airflows are made uniform over the entire circumference, powder dust may be shaken off without any unevenness, and the stability of the filtration capacity is excellent.

In addition, it is favorable that the attaching height 1₂ of the retainer cone 1 is such that the entire length (=x₁+x₂+y₁) of the retainer cone 1 is accommodated within the range of negative pressure generation area in the vicinity of the attaching position of a prior art venturi tube, whereby it is possible to effectively prevent negative pressure from being generated.

The maximum sectional area (horizontal projection area=πz₁²/4) of the retainer cone 1 changes according to the lengths (x₁, x₂) of the upper end shrinkage portion 2 and the lower end shrinkage portion 3. However, it was formed to be 0.2 through 0.4 times the sectional area (horizontal projection area=πa²/4) of the retainer main body 11. As the maximum sectional area (horizontal projection area) of the retainer cone 1 becomes smaller than 0.2 times the sectional area (horizontal projection area) of the retainer main body 11, it becomes difficult to disperse compressed air jetted when carrying out reverse air filtration to the outer circumference of the retainer cone 1, wherein there is a tendency that the negative pressure reducing effect is decreased, and it becomes insufficient to shake off powder dust at the upper end portion of the retainer main body 11. As the maximum sectional area thereof becomes larger than 0.4 times, the sectional area (πa²/4−πz₁²/4) of a flow path at the upper end portion of the retainer main body 11 becomes insufficient, and the amount of compressed air that reaches the lower end side of the retainer main body 11 when carrying out reverse air filtration is likely to become insufficient, wherein it becomes insufficient to shake off powder dust at the lower end side of the retainer main body 11, at the same time, the load of a blower is increased when collecting dust, and it is found that there is a tendency that the drive efficiency is likely to be decreased.

The angle of the top part 2a of the upper end shrinkage portion 2 of the retainer cone 1 changes according to the length x₁ of the upper end shrinkage portion 2. However, it was formed to be 65 through 75 degrees. As the angle α₁ of the top part 2a of the upper end shrinkage portion 2 of the retainer cone 1 becomes smaller than 65 degrees, it becomes difficult for compressed air jetted when carrying out reverse air filtration to be dispersed to the outer circumferential side of the retainer cone 1, and the negative pressure reducing effect is likely to be reduced, wherein there is a tendency that it becomes insufficient to shake off powder dust at the upper end portion of the retainer main body 11. As the angle α₁ becomes larger than 75 degrees, the amount of compressed air that reaches the lower end side of the retainer main body 11 when carrying out reverse air filtration is decreased, wherein there is a tendency that it becomes insufficient for powder dust to be shaken off at the lower end side of the retainer main body 11.

The angle α₂ of the top part 3a of the lower end shrinkage portion 3 of the retainer cone 1 changes according to the length x₂ of the lower end shrinkage portion 3 and the suction pressure of the blower. However, it was formed to 65 through 75 degrees. As the angle α₂ of the top part 3a of the lower end shrinkage portion 3 of the retainer cone 1 becomes smaller than 65 degrees, the length x₂ of the lower end shrinkage portion 3 becomes longer, wherein it was found that there is a tendency for workability and handling performance to be decreased. As the angle α₂ becomes larger than 75 degrees, it was found that there is a tendency that it becomes difficult for clean airflows suctioned when collecting dust to smoothly move along the lower end shrinkage portion 3.

A description is given of a method for using the bag filter retainer equipped with the retainer cone according to Embodiment 1 of the present invention, which has been constructed as described above.

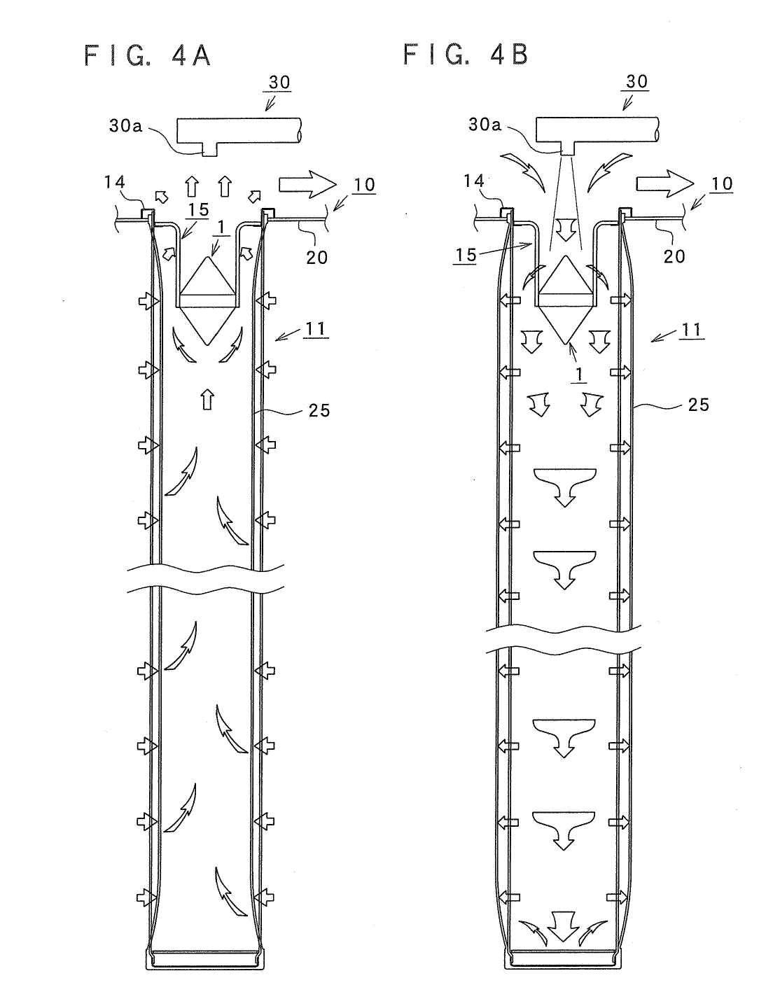

FIG. 4A is a schematic sectional view of the major parts, which shows a state of a filtration fabric of the bag filter retainer equipped with the retainer cone according to Embodiment 1 of the present invention when collecting dust, and FIG. 4B is a schematic sectional view of the major parts, which shows a state of the filtration fabric of the bag filter retainer equipped with the retainer cone according to Embodiment 1 of the present invention when carrying out reverse air filtration.

In FIG. 4, reference numeral 25 denotes a cylindrical filtration fabric disposed at the outer circumference of the retainer main body 11, and 30a denotes a nozzle of a pulse jet type shaking-off mechanism 30 which is disposed upward of the bag filter retainer 10 and jets compressed air to the interior of the retainer main body 11.

As shown in FIG. 4A, airflows including dust flown in from the outside of the filtration fabric 25 when collecting dust, and powder dust is caught and collected on the outer circumference of the filtration fabric 25. Clean airflows from which powder dust is separated, caught, and collected are discharged from the opening portion 14a of the annular-shaped flange portion 14 at the upper end side of the retainer main body 11. At this time, clean airflows that move from the lower end side of the retainer main body 11 to the upper end side thereof may smoothly move along the outer circumference of the retainer cone 1 that is formed to be roughly like a spinning spindle, wherein there is no case where the retainer cone 1 hinders airflows.

In reverse air filtration which is carried out for every fixed duration of time, as shown in FIG. 4B, compressed air is jetted from the nozzle 30a of the shaking-off mechanism 30 into the interior (inside the filtration fabric 25) of the retainer main body 11. At this time, a part of the compressed air moving from the upper end side of the retainer main body 11 to the lower end side thereof is brought into collision with the upper end shrinkage portion 2 of the retainer cone 1 and is dispersed in the radius direction (outer circumference direction) of the retainer main body 11. Therefore, negative pressure is prevented from being generated, and the entire filtration fabric 25 including the upper end side of the retainer main body 11 is roughly evenly outwardly inflated, wherein powder dust adhered to the outer surface of the filtration fabric 25 may be instantaneously shaken off.

Since the negative pressure for suction due to the blower when collecting dust becomes larger at the upper end portion of the retainer main body 11 near the blower, the adhesion amount of powder dust at the upper end portion of the retainer main body 11 becomes greater. However, since the positive pressure at the upper end side of the retainer main body 11, which is near the nozzle 30a for jetting pulse jet, may be made higher than the lower end side thereof by preventing negative pressure from being generated in reverse air filtration by means of the retainer cone 1, it is possible to effectively shake off powder dust adhered to the outer surface of the filtration fabric 25.

Next, referring to the drawings, a description is given of a modified version of the retainer cone according to Embodiment 1 of the present invention.

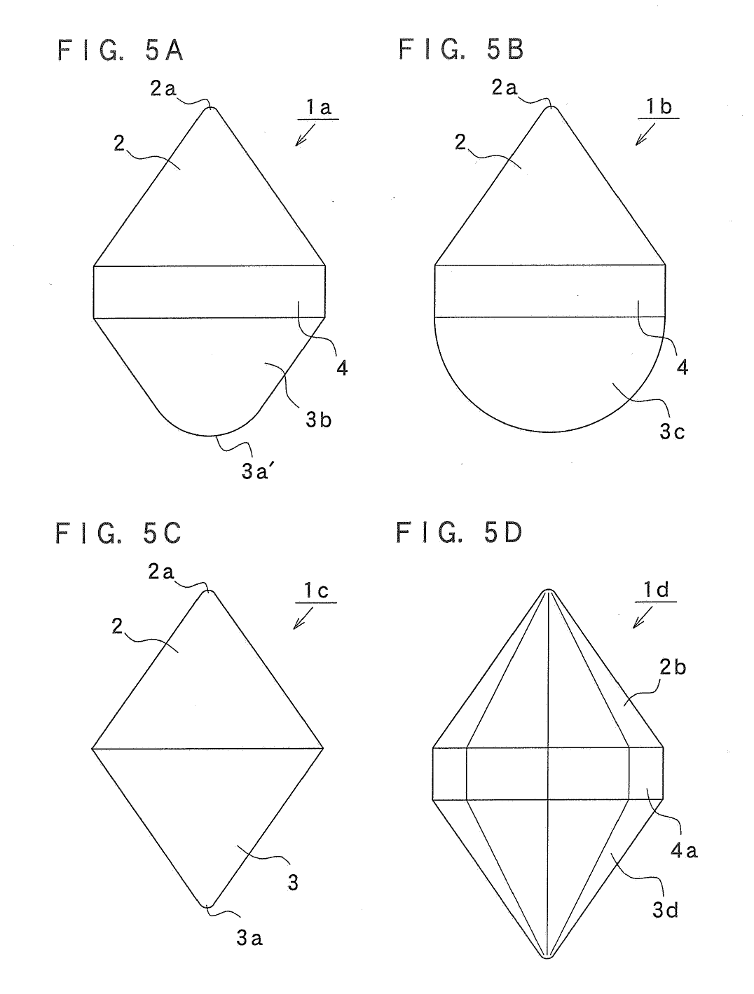

FIG. 5A is a front elevational view showing a first modified version of the retainer cone according to Embodiment 1 of the present invention. FIG. 5B is a front elevational view showing a second modified version of the retainer cone according to Embodiment 1 of the present invention. FIG. 5C is a front elevational view showing a third modified version of the retainer cone according to Embodiment 1 of the present invention, and FIG. 5D is a front elevational view showing a fourth modified version of the retainer cone according to Embodiment 1 of the present invention.

In FIG. 5A, a point at which the retainer cone 1a according to the first modified version differs from the retainer cone 1 according to Embodiment 1 resides in that the upper end shrinkage portion 2 and the lower end shrinkage portion 3b are not vertically symmetrical to each other, and the top part 3a′ of the lower end shrinkage portion 3b is formed to be arcuate with the curvature of the top part 3a′ of the lower end shrinkage portion 3b made smaller than that of the top part 2a of the upper end shrinkage portion 2.

In FIG. 5B, a point at which the retainer cone 1b according to the second modified version differs from the retainer cone 1 according to Embodiment 1 resides in that the lower end shrinkage portion 3c is formed to be semi-spherical.

In FIG. 5C, a point at which the retainer cone 1c according to the third modified version differs from the retainer cone 1 according to Embodiment 1 resides in that no columnar barrel portion 4 is formed between the upper end shrinkage portion 2 and the lower end shrinkage portion 3.

In FIG. 5D, a point at which the retainer cone 1d according to the fourth modified version differs from the retainer cone 1 according to Embodiment 1 resides in that the upper end shrinkage portion 2b and the lower end shrinkage portion 3d are formed to be like an octagonal cone, and an octagonal columnar barrel portion 4a is formed between the upper end shrinkage portion 2b and the lower end shrinkage portion 3d.

As described above, in the present embodiment, a description was given of such types in which a conical shape, elliptic semi-spherical shape, or a semi-spherical shape lower end shrinkage portion 3 (3b, 3c) is combined with a conical upper end shrinkage portion 2, and in which an octagonal columnar upper end shrinkage portion 2b and an octagonal lower end shrinkage portion 3d are combined with each other. However, the shape of the retainer cone is not limited to these combinations. Other than the conical shape, an elliptic semi-spherical shape, a semi-spherical shape, a cannonball shape, or a polygonal shape other than an octagonal cone may be used as the upper end shrinkage portion 2. Also, a cannonball shape and polygonal conical shape other than the octagonal cone may be used as the lower end shrinkage portion 3. In particular, where the retainer cone is formed of an axially symmetrical body of rotation as shown in FIG. 1 and FIGS. 5(a) through (c), this is favorable in that distribution of pressure and streams of airflows may be made uniform on the entire circumference, and efficient filtration may be carried out on the entire surface of the filtration fabric 25 without any unevenness.

Since the retainer cone according to Embodiment 1 of the present invention is constructed as described above, the following actions may be brought about

(1) Since the retainer cone 1 is provided with an upper end shrinkage portion 2, which shrinks toward the upper end thereof, at the upper end portion in the lengthwise direction thereof, a part of the compressed air may be dispersed in the radius direction (the outer-circumferential direction) of the retainer main body 1 so as to be reflected on the inclined surface of the upper end shrinkage portion 2 when the compressed air is jetted from the nozzle 30a disposed at the upper part of the bag filter retainer 10 in reverse air filtration of the filtration fabric 25, it is possible to prevent negative pressure from being generated at the upper end side of the retainer main body 11, the entire filtration fabric 25 including the upper end side of the retainer main body 11 may be roughly uniformly outwardly inflated, and it is possible to securely shake off powder dust adhered to the filtration fabric 25, wherein maintenance reliability thereof is excellent, dust collection efficiency may be improved by widening the effective filtration area when collecting dust, and excellent energy-saving performance is brought about.
(2) Since, when carrying out reverse air filtration of the filtration fabric 25, a part of the compressed air jetted from the nozzle 30a disposed at the upper part of the bag filter retainer 10 is dispersed from the upper end shrinkage portion 2 of the retainer cone 1 in the radius direction (the outer-circumferential direction) of the retainer main body 11, it is possible to prevent negative pressure from being generated at the upper end side of the retainer main body 11 and to prevent the filtration fabric 25 from being damaged by alleviating sticking of the filtration fabric 25 due to intensive pulling against the retainer main body 11 at the upper end side of the retainer main body 11, wherein the service life of the filtration fabric may be improved.
(3) Since the retainer cone 1 is internally inserted into the center portion at the upper end side of the bag filter retainer 10, it is possible to further enlarge the sectional area of a flow path at the upper end portion of the retainer main body 11 in comparison with a prior art venturi tube, using the outer circumference of the retainer cone 1 as a flow path, and it is possible to significantly reduce the load of a blower used for suction when collecting dust, wherein an excellent energy-saving effect may be brought about.
(4) Since a lower end shrinkage portion 3 is provided which is shrunk toward the lower end and formed at the lower end portion in the lengthwise direction of the retainer cone 1, it is possible to smoothly move filtrated clean airflows to the upstream side along the inclined surface of the lower end shrinkage portion 3 when suctioning by means of a blower when collecting dust, wherein the pressure loss is only slight, and suction efficiency is excellent.
(5) Since the upper end shrinkage portion 2 of the retainer cone 1 is formed to be a conical shape, compressed air jetted when carrying out reverse air filtration may be radially and uniformly dispersed from the center (the axial center) of the retainer main body 11 toward the outer circumferential side without any unevenness. The filtration fabric 25 may be securely outwardly inflated over the entire circumference at the upper end side of the retainer main body 11, wherein it is possible to efficiently shake off powder dust.
(6) Since the lower end shrinkage portions 3, 3b, 3c and 3d are, respectively, formed to be a conical shape, an elliptic semi-spherical shape, a semi-spherical shape, and a polygonally conical shape, it is possible to smoothly move clean airflows suctioned when collecting dust roughly uniformly to the upstream side along the entire circumference of the lower end shrinkage portion 3 without any unevenness, wherein the load of the blower may be reduced, and excellent energy-saving performance may be brought about.

Since a bag filter retainer equipped with a retainer cone according to Embodiment 1 of the present invention is constructed as described above, the following actions may be brought about.

(1) Since the retainer cone 1 is internally inserted into and disposed in the center portion of the upper end side of the retainer main body 11, a part of the compressed air jetted from the nozzle 30a at the upper part of the retainer main body 11 in reverse air filtration of the filtration fabric 25 is dispersed in the radius direction of the retainer main body 11, and negative pressure may be prevented from being generated at the upper end side of the retainer main body 11. The entirety of the filtration fabric 25 including the upper end side of the retainer main body 11 is outwardly inflated, and powder dust adhered to the filtration fabric 25 may be securely shaken off. An effective filtration area when collecting dust may be widened and it is possible to improve the dust collection efficiency. Simultaneously, it is possible to prevent the filtration fabric 25 from being damaged by alleviating sticking of the filtration fabric 25 due to intensive pulling against the retainer main body 11 at the upper end side of the retainer main body 11, wherein the service life of the filtration fabric may be improved.
(2). Since the retainer cone 1 is internally inserted into and disposed in the center portion at the upper end side of the retainer main body 11, the sectional area of a flow path at the upper end portion of the retainer main body 11 may be enlarged in comparison with a prior art venturi type, wherein the load of a blower used for suction when collecting dust may be significantly reduced, and excellent energy-saving performance may be brought about.
(3) Since the retainer main body 11 is provided with fixing members 15 for fixing the retainer cone 1, it is possible to easily attach the retainer cone 1 to the existing retainer main body 11 to effectively utilize the existing retainer main body 11, and the filtration performance and service life of the filtration fabric may be improved to a large extent.
(4) Since the negative pressure for suction by a blower when collecting dust becomes larger at the upper end portion of the retainer main body 11 near the blower, the amount of powder dust adhered to the upper end portion of the retainer main body 11 is increased. However, by attaching the retainer cone 1 and preventing negative pressure from being generated due to a pulse jet (compressed air) when carrying out reverse air filtration, it is possible to obtain high positive pressure by a pulse jet at the upper end side of the retainer main body 11. Therefore, an effect of shaking off powder dust may be improved, and excellent energy-saving performance may be brought about.
(5) Since, based on a negative pressure reducing effect when carrying out reverse air filtration of the retainer cone 1, positive pressure is generated in the interior of the retainer main body 11 in proportion to the pressure of a pulse jet (compressed air) when carrying out reverse air filtration, and the filtration fabric 25 may be deformed, it is possible to select the pressure of the pulse jet (compressed air) in a wide range from low pressure (for example, approximately 196 kPa) to high pressure (for example, approximately 686 kPa), and it is easy to control the pressure of the pulse jet (compressed air), wherein handling performance and versatility are excellent.
(6) Since the suspension portion 16a of the fixing member 15 is disposed parallel to the lengthwise direction of the retainer main body 11 on the outer circumference of the columnar barrel portion 4 of the retainer cone 1, the extension portion 16b extending from the suspension portion 16a may be simply fixed so as to be locked at the opening edge portion 14b of the annular-shaped flange portion 14, which is disposed at the upper end portion of the retainer main body 11 without hindering streams of clean airflows when collecting dust and compressed air when carrying out reverse air filtration, wherein attaching performance is excellent.

### Embodiment 2

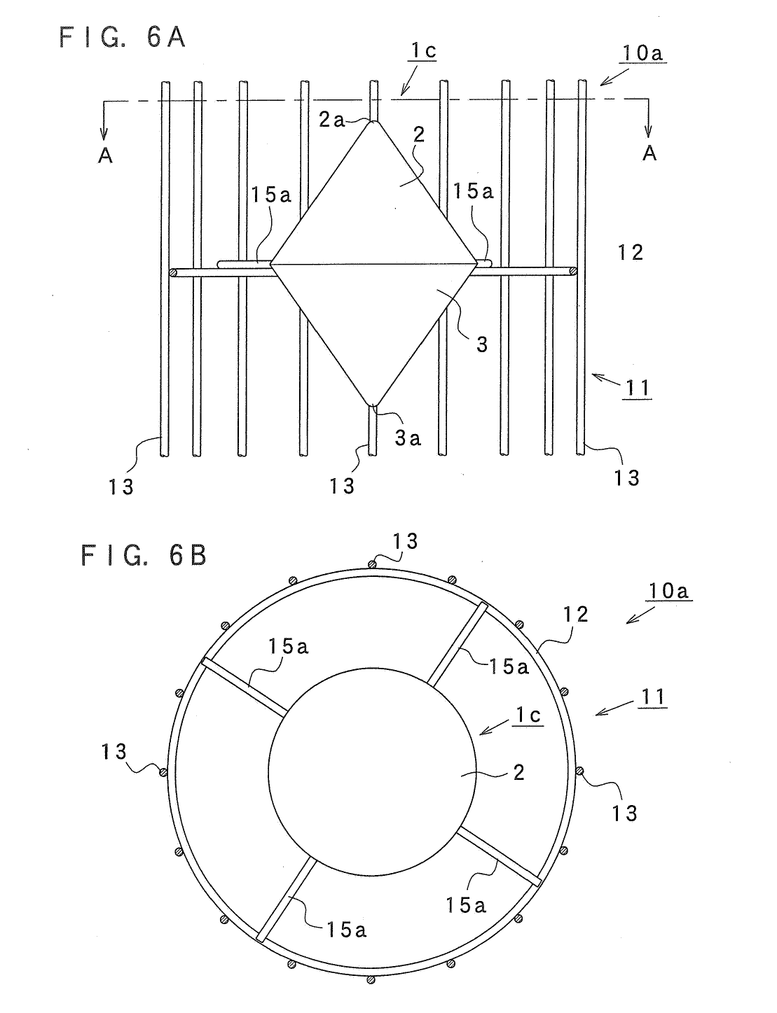

FIG. 6A is a sectional front elevational view showing the section of the major parts of the bag filter retainer equipped with the retainer cone according to Embodiment 2 of the present invention, and FIG. 6B is a perspective sectional view taken along the line A-A in FIG. 6A. Also, components that are identical to those of Embodiment 1 are given the same reference numerals, and description thereof is omitted.

In FIG. 6, a point at which a bag filter retainer 10a equipped with a retainer cone according to Embodiment 2 differs from that according to Embodiment 1 resides in that four fixing members 15a are radially disposed in the radius direction of the retainer main body 11 on the outer circumference of the retainer cone 1c with equiangular spacing, and are welded to and fixed at the fixing ring 12 of the retainer main body 11.

If one end of the fixing member 15a is fixed, by welding or screwing, on the outer circumference of the retainer cone 1c in advance, it is possible to securely and firmly fix the retainer main body 11 and the retainer cone is by internally inserting the retainer cone is into the retainer main body 11 and welding the other end of the fixing member 15a to the fixing ring 12 of the retainer main body 11. In addition, the other end of the fixing member 15a may be fixed to the longitudinal line member 13 of the retainer main body 11.

Although, in the present embodiment, the retainer cone 1c is used, any one of the retainer cones 1, 1a, and 1b that have been described in Embodiment 1 may be used.

The fixing member 15 that is similar to that of Embodiment 1 may be used for fixing instead of the fixing member 15a.

The quantity and arrangement of the fixing members 15a are the same as those in Embodiment 1. Therefore, the description thereof is omitted.

Since a bag filter retainer equipped with a retainer cone according to Embodiment 2 of the present invention is constructed as described above, the following actions may be brought about in addition to those obtained in (1) through (5) of Embodiment 1.

(1) Since the fixing member 15a is radially disposed in the radius direction of the retainer main body 11 on the outer circumference of the retainer cone 1c, and is fixed to at least any one of the longitudinal line member 13 and the fixing ring 12 of the retainer main body 11, it is possible to securely support the outer circumference of the retainer cone 1c without hindering streams of clean airflows when collecting dust and compressed air when carrying out reverse air filtration, wherein fixing stability thereof is excellent.

### EXAMPLES

Hereinafter, a further detailed description is given of the present invention based on examples.

### Example 1

The pressure was measured when carrying out reverse air filtration, using a bag filter retainer equipped with the retainer cone described in Embodiment 1.

The bag filter retainer 10 used for the pressure measurement was constructed so that the diameter a of the retainer main body 11 is 160 mm, the entire length of the retainer main body 11 is 9000 mm, the entire length of the retainer cone 1 is 128 mm, the angles α₁ and α₂ of the top parts 2a and 3a of the upper end shrinkage portion 2 and the lower end shrinkage portion 3 of the retainer cone 1 are 70 degrees, respectively, the diameter z₁ of the columnar barrel portion 4 of the retainer cone 1 is 80 mm, the length y₁ of the columnar barrel portion 4 is 18 mm, and the attaching height 1₂ from the upper surface of the annular-shaped flange portion 14 to the upper end of the columnar barrel portion 4 of the retainer cone 1 is 100 mm (Refer to FIG. 2).

A pulse jet (compressed air) of 294 kPa was jetted from the nozzle 30a to the bag filter retainer 10 for 0.2 seconds, and the pressure was measured at respective positions of 200 mm, 350 mm and 3000 mm from the upper end of the bag filter retainer 10 (Refer to FIG. 4).

In addition, a digital fine pressure difference meter (made by Nagano Keiki Co., Ltd., Model GC62) was used for measurement of pressure, the pressure range (measurement range) of which was −5 kPa through 5 kPa. Measurement values were displayed based on comparator output (Response: within 5 ms), and a graph thereof was plotted based on analog output (Response: within 50 ms). And, the maximum pressure and the minimum pressure, which were applied to the pressure port, were recorded in an internal memory as the peak value and the bottom value based on a peak-hold feature of the digital fine pressure difference meter.

### Example 2

The pressure was measured in the same way as those of Example 1 other than that the pulse jet (compressed air) jetted from the nozzle 30a was set to 490 kPa.

### (Comparative Control 1)

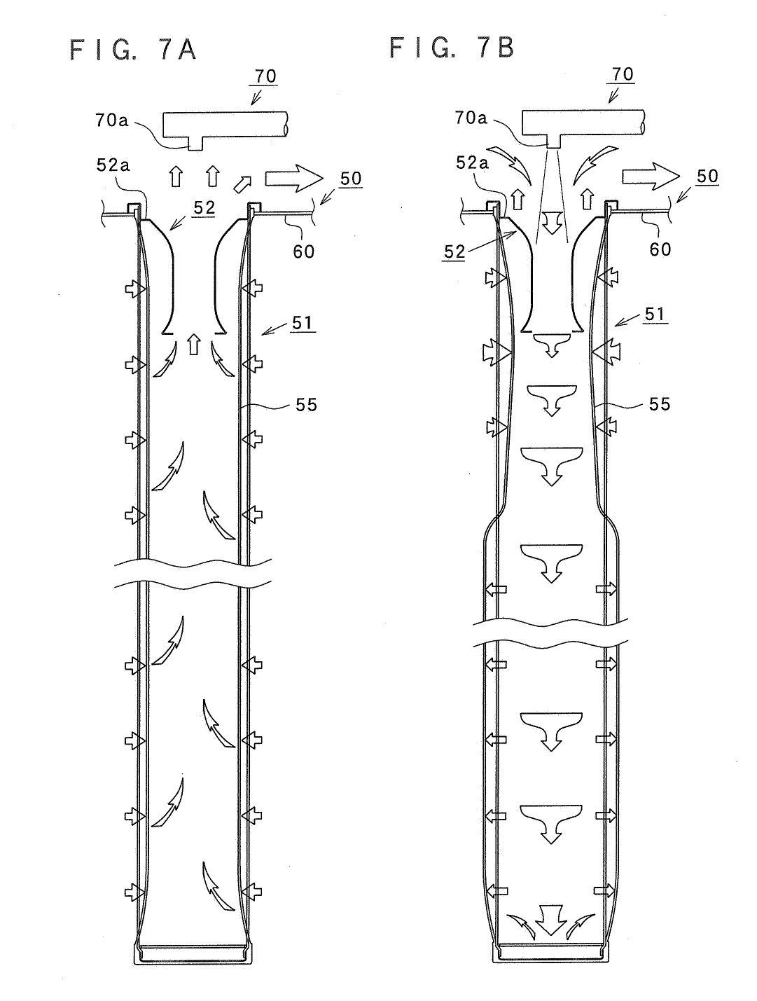

The pressure was measured in the same way as those of Example 1 other than that a prior art venturi tube 52 (Refer to FIG. 7) was attached instead of the retainer cone 1.

### (Comparative Control 2)

The pressure was measured in the same way as those of Comparative Control 1 other than that the pulse jet (compressed air) jetted from the nozzle 30a was set to 490 kPa.

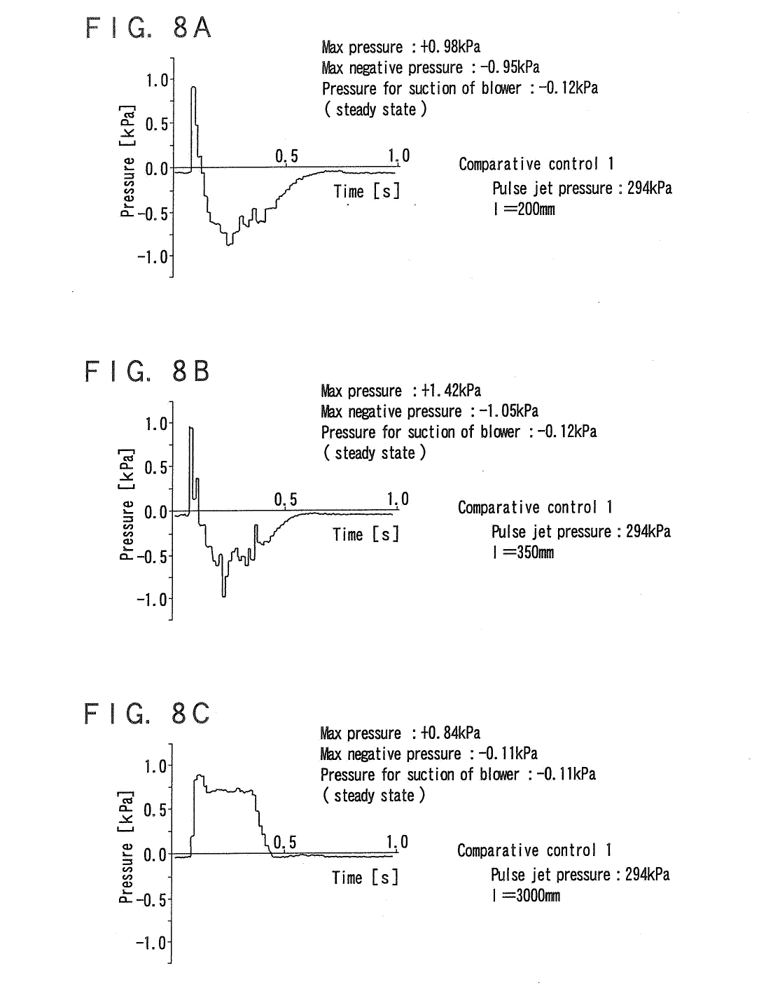

FIG. 8 through FIG. 11 are views showing the results of pressure measurement. Also, in FIG. 8 through FIG. 11, the abscissa indicates time, and the ordinate indicates pressure. In addition, in terms of graphs, portions exceeding the display range (±1.25 kPa) are cut off, and there are cases where the peak value that cannot follow the response of analog output is not expressed. However, the maximum pressure and the maximum negative pressure, which are described in the drawings, are respectively the values of the maximum pressure (peak value) and minimum pressure (bottom value) that are stored in the internal memory of the digital fine pressure difference meter, and this is unrelated to the measurement.

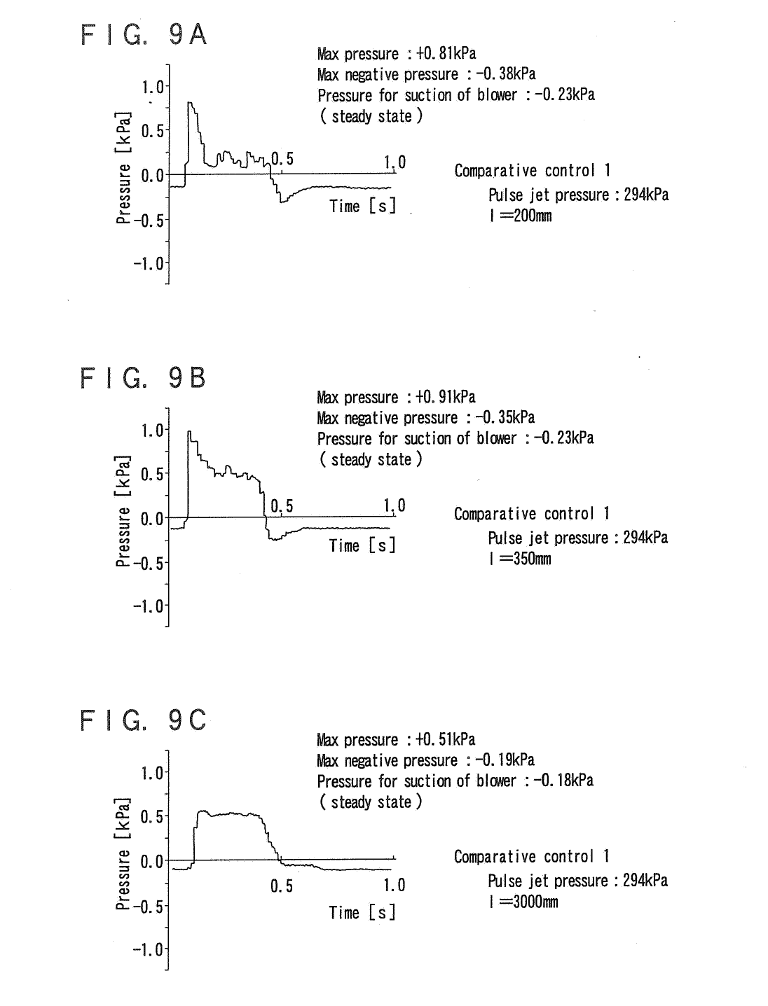

According to the results of measurement based on the Comparative Control 1 in FIGS. 8(a) through (c) and the results of measurement based on Example 1 in FIGS. 9(a) through (c), almost no negative pressure is generated at the upper end side (1=200 mm and 350 mm) of the retainer main body 11 in Example 1 (Refer to FIGS. 9(a) and (b)) while negative pressure is generated at the upper end side (1=200 mm and 350 mm) of the retainer main body 11 in the prior art Comparative Control 1 (Refer to FIGS. 8(a) and (b)), wherein it was made clear that powder dust adhered to the filtration fabric 25 could be securely shaken off by carrying out reverse air filtration.

Also, it was made clear that, in areas other than the area, where negative pressure is generated, at the upper end side of the retainer main body 11, sufficient positive pressure was obtained at either Comparative Control 1 of FIG. 8(c) and Example 1 of FIG. 9(c), and the pressure state was coincident with the situation of shaking off powder dust.

In addition, in Comparative Control 1, positive pressure was generated only instantaneously (approx. 0.02 seconds) when a pulse jet (compressed air) was jetted (refer to FIG. 8(a), (b)). However, it was made clear that, since the time is very short, the filtration fabric 25 does not react, and it remains in an suction state, wherein it is not possible to shake off powder dust.

Further, the pressure in a steady state where sufficient time has elapsed from jetting of a pulse jet (compressed air) indicates the suction pressure of a blower. However, the pressure of Embodiment 1 was −0.23 through −0.18 kPa while the pressure in Comparative Control 1 was −0.12 through −0.11 kPa, wherein it was made clear that the suction efficiency was improved, and the load of the blower could be reduced to a large extent.

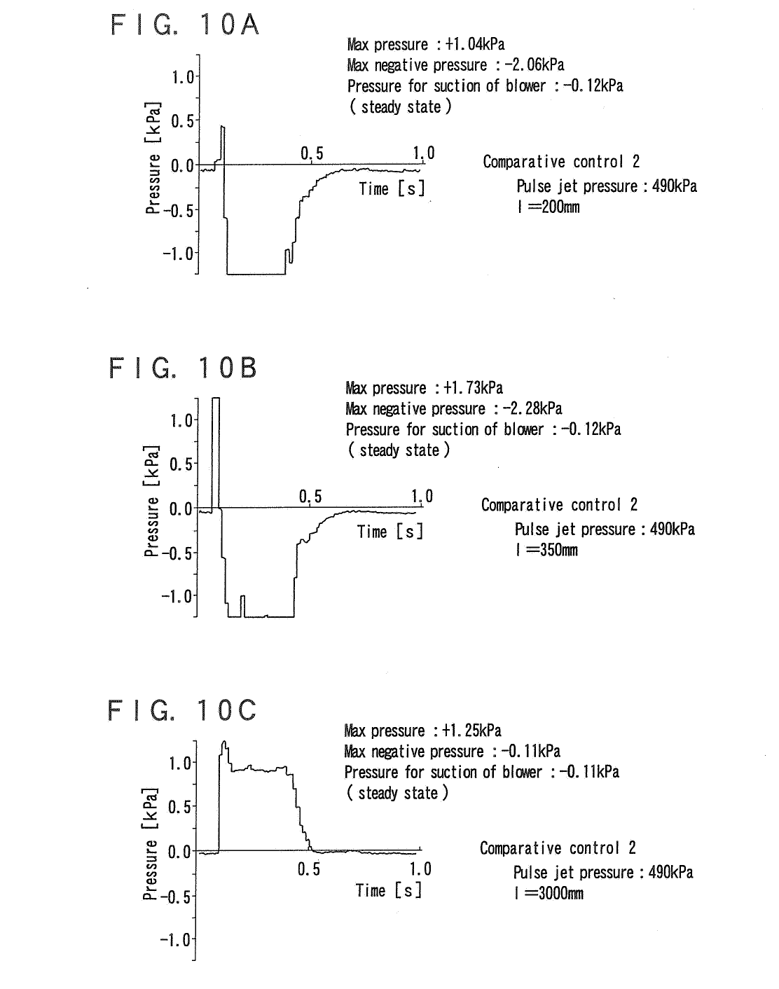

According to the results of measurement in Comparative Control 1 in FIG. 8(a) through (c) and the results of measurement of Comparative Control 2 in FIG. 10(a) through (c) it was made clear that, in such a type to which a prior art venturi tube 52 (Refer to FIG. 7) is attached, if the pressure of a pulse jet (compressed air) is increased, the negative pressure at the upper end side (1=200 mm and 350 mm) of the retainer main body 11 is increased (Refer to FIG. 8(a), (b), and FIG. 10(a) and (b)) while the positive pressure is increased (Refer to FIG. 8(c), and FIG. 10(c)) at a position far (by 1=3000 mm) from the area, where negative pressure is generated, at the upper end side of the retainer main body 11, wherein the filtration fabric 25 is intensively pulled against the retainer main body 11, and is likely to be damaged.

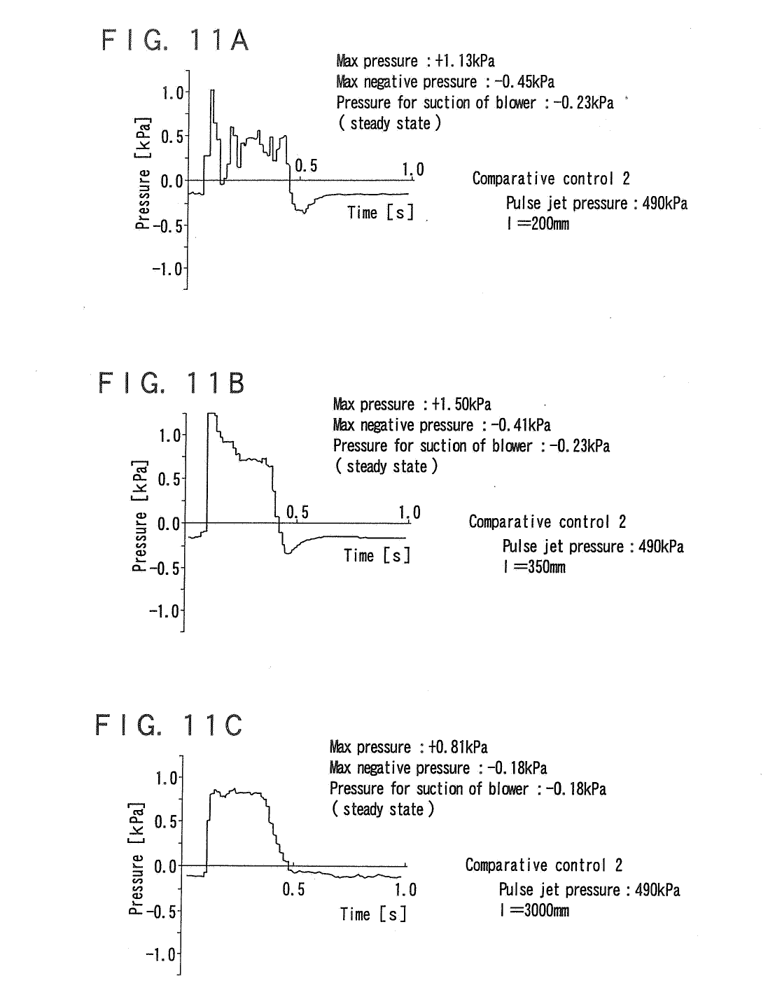

To the contrary, according to the results of measurement of Example 1 in FIG. 9(a) through (c) and the results of measurement of Example 2 in FIG. 11(a) through (c), it was made clear that, in such a type to which the retainer cone 1 is attached, if the pressure of the pulse jet (compressed air) is increased, positive pressure is proportionally increased over the entire length of the retainer main body 11, and the effect of shaking off powder dust is improved.

Further, the phenomenon, in which negative pressure is generated at the upper end side of the retainer main body as has been observed in Comparative Controls 1 and 2, may be seen in a retainer not equipped with a venturi tube (however, the intensity and distribution of the negative pressure differ). It is obvious that phenomenon, in which negative pressure is generated at upper end side of the retainer main body may be improved by attaching a retainer cone according to the present invention.

### INDUSTRIAL APPLICABILITY

The present invention provides a retainer cone that, by internally inserting the retainer cone into the central portion at the upper end portion of the retainer, which is an area, where negative pressure is generated, in the vicinity of the attaching portion of a prior art venturi tube, is capable of dispersing a part of the compressed air jetted from a nozzle of the upper part of the retainer main body, when carrying out reverse air filtration of a filtration fabric, in the radius direction of the retainer main body, preventing negative pressure from being generated at the upper end side of the retainer main body, outwardly inflating the entire filtration fabric including the upper end side of the retainer main body, securely shaking off powder dust adhered to the filtration fabric, and simultaneously enlarging the sectional area of a flow path at the upper end portion of the retainer in comparison with a prior art venturi tube, and significantly reducing the load of a blower used for suction when collecting dust; and the present invention provides, by being equipped with the same retainer cone, a bag filter retainer that is capable of preventing the filtration fabric from being damaged by alleviating sticking of the filtration fabric at the upper end side of the retainer main body when carrying out reverse air filtration, has an excellent service life in regard to the filtration fabric, is capable of widening an effective filtration area when collecting dust, and improving the dust collection efficiency, and brings about an excellent energy-saving effect. Therefore, the retainer cone and bag filter retainer equipped with the same contribute to resource saving and energy saving by attempting to improve the filtration efficiency of the existing dust collector and to lengthen the service life of a filtration fabric.

1. A retainer cone internally inserted into and disposed in the center portion at the upper end side of the retainer main body of a bag filter retainer, comprising an upper end shrinkage portion shrunk toward the upper end and formed at the upper end portion in the lengthwise direction thereof, and a lower end shrinkage portion shrunk toward the lower end and formed at the lower end portion in the lengthwise direction thereof.

2. The retainer cone according to claim 1, wherein the upper end shrinkage portion and the lower end shrinkage portion are, respectively, formed to be any one of a conical shape, a semi-spherical shape, an elliptic semi-spherical shape, a cannonball-shape, or a polygonal cone.

3. The bag filter retainer comprising: a retainer main body consisting of a plurality of fixing rings formed of metallic wires to be made annular, and disposed with predetermined spacing, and a plurality of longitudinal line members jointed to the outside of the fixing rings; a retainer cone internally inserted into and disposed in the center portion at the upper end side of the retainer main body and described in claim 1 or 2; and a fixing member for fixing the retainer cone on the retainer main body.

4. The bag filter retainer according to claim 3, wherein the fixing member includes a suspension portion disposed on the outer circumference of the retainer cone parallel to the lengthwise direction of the retainer main body, and an extension portion extending from the suspension portion and fixed at the annular-shaped flange portion disposed at the upper end portion of the retainer main body.

5. The retainer cone according to claim 3, wherein the fixing member is radially disposed in the radius direction of the retainer main body on the outer circumference of the retainer cone and is fixed to any one of the longitudinal line members of the retainer main body and the fixing ring thereof.
